(19) United States
(12) Patent Application Publication
(10) Pub. No.: US 2007/0135990 A1
(43) Pub. Date: Jun. 14, 2007

(54) Navigation route information for traffic management

(76) Inventors: Shafer B. Seymour, Bartlett, IL (US); Ramy P. Ayoub, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/299,150

(22) Filed: Dec. 8, 2005

(51) Int. Cl. G08G 1/00

(52) U.S. Cl. 701/117; 340/995.13; 701/210

(57) ABSTRACT

The present disclosure provides a traffic management system that utilizes route information provided by on board navigation systems installed in commuter vehicles to predict traffic congestion and determine appropriate traffic management procedures. Traffic management procedures include adjusting the timing of traffic signals, providing traffic updates/instructions to roadside Dynamic Message Signs (DMSs), actuating movable lane barriers, etc. The predictive traffic management capabilities provided by the present system offer an advantage over existing systems because the present system can more reliably predict when and where traffic congestion will occur and implement proactive, rather than reactive, traffic management procedures to deal with congestion before it occurs.

### CROSS REFERENCE TO RELATED APPLICATIONS

This application is concurrently filed with U.S. Patent Application Ser. No. ______, entitled “Predictive Navigation,” which is incorporated herein by reference in its entirety.

### FIELD OF THE INVENTION

This invention relates to traffic management on roadway systems. More specifically, the invention relates to a traffic management system that utilizes route information provided by on-board vehicle navigation systems.

### BACKGROUND

FIG. 1 schematically illustrates a basic traffic management system 100, as is known in the art. System 100 includes a management center 101 that receives information from a variety of information sources 102 and implements traffic management procedures on roadways 103 based on the received information. Traffic management procedures typically include adjusting the timing of traffic signals 104, providing traffic updates/instructions to roadside Dynamic Message Signs (DMS) 105, actuating movable lane barriers, etc.

Traffic management center 101 requires reliable information concerning current and future traffic conditions in order to effectively implement such traffic management procedures. Presently available information sources 102 include traffic sensors 106, weather service reports 107, incident reports 108, event promoters 109, and emergency/police dispatch 110. Traffic sensors 106 include devices such as cameras, electronic sensors, and the like distributed about the roadways to provide real time information about the number of cars at various locations. Incident reports 108 provide information concerning accidents, construction, etc. Event promoters 109 can provide advanced warning of high density traffic due to sporting events, concerts, etc. Emergency/police dispatch 110 can provide information about the present position and the planned routes of emergency/police vehicles so that management center 101 can implement procedures to provide these vehicles with priority on the roadways.

Management system 101 includes computing resources 111 to receive and process information, compute appropriate traffic management procedures, and transmit instructions for implementing traffic management procedures. Management system 101 also typically includes storage resources 112 for storing information relating to historic traffic trends as data by which future traffic behavior can be predicted.

The majority of vehicles on the roadways are commuter vehicles. The most important information required to efficiently manage traffic flow is information concerning the present congestion of commuter vehicles at various locations on the roadway and information concerning predicted future congestion at various locations. Present congestion is provided primarily by traffic sensors 106. Future congestion is largely predicted based on present congestion, historical trends, etc. Such predictions are inherently uncertain. The effectiveness of traffic management systems 101 would be increased by the availability of reliable predictions of the future location of commuter vehicles on the roadway.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a prior art traffic management system.

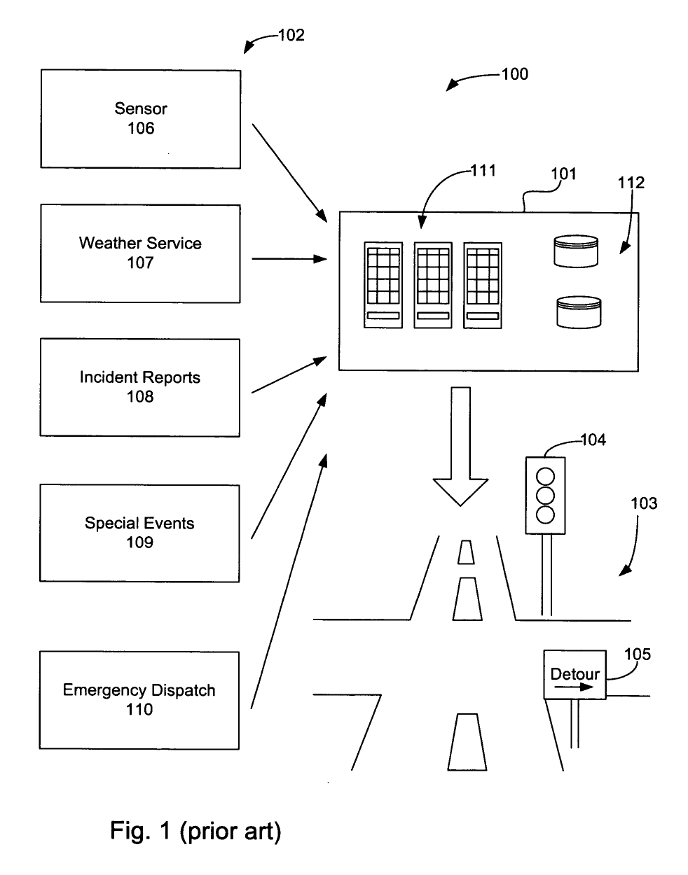

FIG. 2 illustrates a traffic management system capable of using route information provided by on board navigation systems to predict traffic flow and manage traffic accordingly.

FIG. 3 illustrates a planned route of a vehicle as transmitted to the traffic management system.

### DETAILED DESCRIPTION

The present disclosure provides a traffic management system that utilizes route information from commuter vehicles for computing and implementing traffic management procedures. Route information is provided to the traffic management system via on-board navigation systems installed in commuter vehicles. This route information, collected for a large number of vehicles on the roadways at a given time, is used to predict short-term future traffic behavior. Such route information is a more reliable indicator of short-term future traffic congestion when compared to predictions based on historical traffic trends, because route information expresses with more certainty the intended future position of a given vehicle. Thus, the predictive traffic management capabilities provided by the present system offer an advantage over existing systems because the present system can more reliably predict when and where traffic congestion will occur and implement proactive, rather than reactive, traffic management procedures to deal with congestion before it occurs.

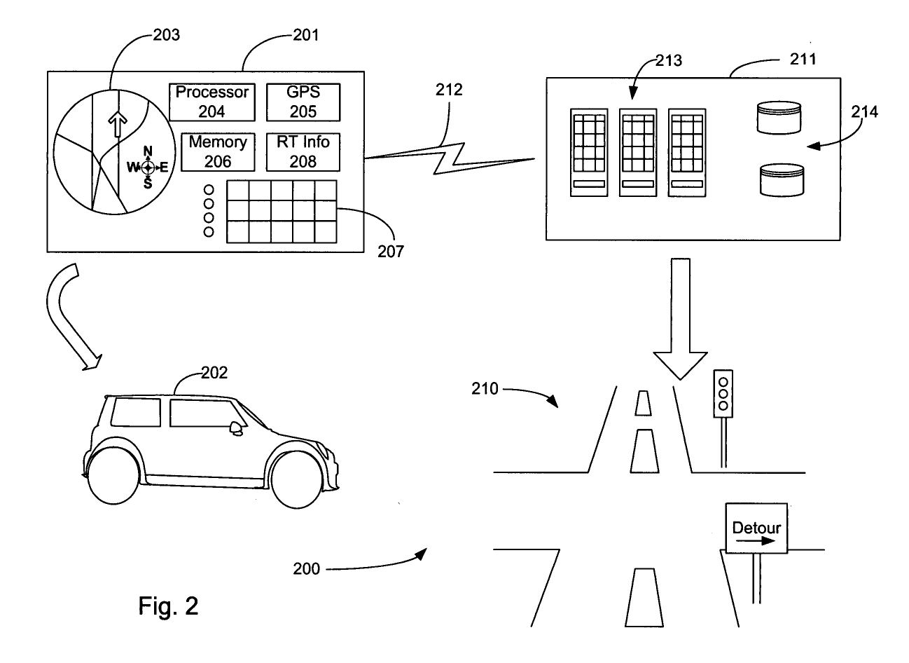

FIG. 2 illustrates a traffic management system 200 that includes a traffic management center 211 configured to utilize route data provided by a plurality of on-board navigation systems 201 installed in a plurality of vehicles 202. On-board navigation systems, which are becoming increasingly common in commuter vehicles, are known in the art and will be discussed only briefly here. Such navigation systems 201 typically feature a display 203 for displaying graphical or text data, for example present position or driving directions; a processor 204; a global positioning system (GPS) receiver 205; a memory/storage 206; and a user input interface 207. Many systems also include additional real-time (RT) receiver(s) 208 for receiving real time information such as traffic reports, weather, etc.

A user of navigation system 201 can use the system to find and plan the most efficient route to a destination, in accordance with the user's preferences. The user may prefer to plan a route according to shortest distance, shortest time, or avoiding highways or tollways. Memory/storage 206 typically contains map data for a given zone of interest, for example, the user's city, state, and/or region. A user wanting directions to a particular destination inputs the address of the destination using input interface 207. The processor 204 determines one or more routes to the destination based on the map data, user preferences and user's present position supplied by GPS receiver 205. The processor may also consider real time traffic conditions provided by RT receiver 208 in formulating the route(s).

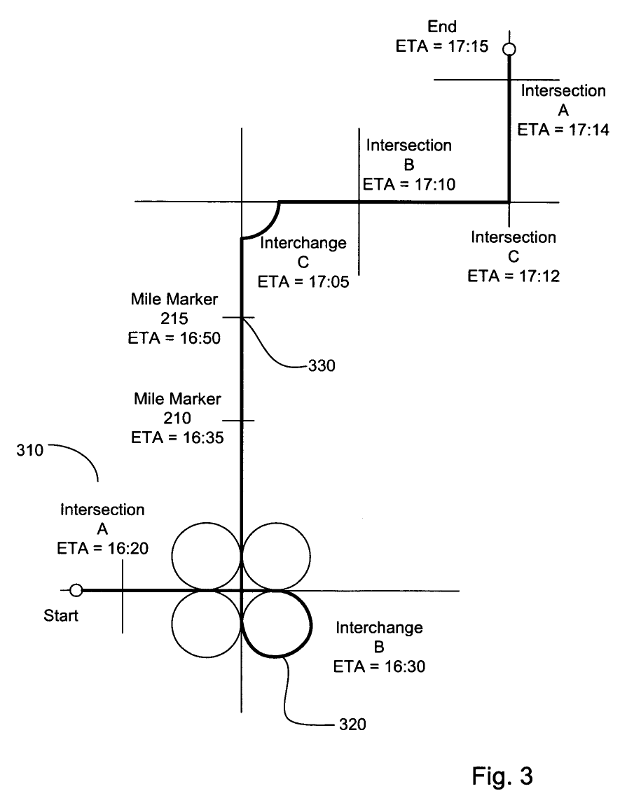

According to one embodiment, the navigation systems calculate the estimated times of arrival (ETA) along predefined points of the route, herein referred to as intra-route ETA data. Predefined points of the route include, but are not limited to, intersections, highway exchanges, bridges, tunnels and mile markers on the highways. This information may or may not be of use to the user, but will be of use to the traffic management system in helping to predict traffic congestion information. FIG. 3 illustrates a planned route 300 of a vehicle as transmitted to the traffic management system. The planned arrival time at intersection A 310 is estimated to be 16:20 by the navigation system. The accurate real time clock provided by GPS assists in the determination of ETA, along with accurate navigation map data. The ETA at interchange 320 is 16:30. The ETA at highway mile markers 210 and 215 are shown as 16:35 and 16:50 respectively. The cumulative route and ETA information from the navigation systems 201 are transmitted to the traffic management center 211.

The vehicle navigation system 201 in one embodiment constantly monitors the progress of the vehicle 202 along the route and re-calculates the ETA information as the vehicle 202 progresses along the route. Modifications to the route ETA information are transmitted to the traffic management center 211 to provide an update to the calculated congestion information. The information can be provided with a vehicle identifier, so that the traffic management center 211 can distinguish new routes from updated routes. The driver can also deviate from a planned route, or may be re-routed due to real-time traffic information received at the navigation system 201. In either case, new route and intra-route ETA data can be recalculated by the vehicle navigation system 201 and transmitted to the traffic management center 211.

In another embodiment, the vehicle navigation system 201 provides the traffic management center 211 with navigation route information, as well as periodic GPS location data. Based on the periodic GPS location data from the vehicle 202, the traffic management system 211 predicts the intra-route ETA information for each vehicle 202 reporting this information. The intra-route ETA information may also be calculated using the same map and travel time information used by the in-vehicle navigation systems 201.

As navigation systems 201 become common in commuter vehicles 202, these systems 201 are a rich source of data that can be utilized for predicting traffic congestion and implementing traffic management procedures to deal with congestion. An aspect of the present disclosure is to provide a traffic management system 200 configured to utilize data provided by navigation systems 201 installed in commuter vehicles 202 to predict traffic congestion and to implement traffic control procedures to deal with the predicted congestion.

Traffic management system 200 utilizes route information calculated by various navigation systems 201 to predict future traffic conditions on roadway system 210. Navigation systems 201 communicate with traffic management center 211 via communication link 212 to provide the current position, destination, and planned route of the vehicle 202. Communication link 212 can be any wireless link using any protocol known in the art, such as dedicated short range communication (DSRC), IEEE 802.11, etc. Communications link 212 can also comprise a cellular connection or a satellite connection. Receipt of the various communication links 212 from the various vehicles 202 is ultimately received by at least one receiver contained within or coupled to the traffic management center 211 (not shown). Normally, the center 211 is coupled to receive communications from a plurality of receivers, each covering a different region within a travel area.

Thus, for each of the commuter vehicles 202 on the roadway that transmit route data, the traffic management center 211 knows the present location of the commuter vehicles 202 and has an intra-route ETA information of the vehicles' future positions during the duration of their trip. The traffic management center 211 can use this information, along with the additional information such as sensor data, weather information, etc. described above, to calculate and implement traffic flow control functions. The traffic management center 211 can continually update the traffic flow control strategy periodically based on the real time location of vehicle 202, provided by the GPS receiver 205.

The traffic management center 211 is similar to the management center described in the Background section. The traffic management center 211 includes computing resources 213 and storage resources 214. Computing resources 213 are configured to predict traffic congestion based on route information received from navigation systems 201 installed in commuter vehicles 202 as well as information received from the various data sources described in the Background section above. The computing resources 213 are configured to predict traffic congestion and determine appropriate traffic control procedures to minimize the congestion. Methods of predicting traffic congestion and appropriate traffic control responses are known in the art. For example, neural network methods of controlling traffic are described in U.S. Pat. Nos. 5,459,665 and 5,668,717, which are hereby incorporated by reference in their entirety. A fuzzy logic system and method for controlling traffic and traffic lights and distributing warning messages to motorists is described in U.S. Pat. No. 6,317,058, which is hereby incorporated by reference in its entirety.

What is different compared to such prior traffic management systems comprises processing of the route information provided by the vehicles 202. A traditional system acquires, for example, the current coordinates of a plurality of vehicles, and uses statistics based on historical data to determine where congestion is likely to occur. For example, by using the current positions of the vehicles and knowing other factors relevant to traffic patterns (e.g., time of day, day of weeks, etc.), a traditional traffic management system will use predictive statistics to determine future likely traffic patterns, and ultimate a traffic management plan. By contrast, in the disclosed traffic management system 200, the future position of a given vehicle 202 (or at least some subset of vehicles in a given area) need not be predicted, but is known via the route information, intra-route ETA information, and the user's present position. Thus, the system 200 can reliably compute the future position of at least some of the vehicles in a given area. If the user does deviate from the route, then new route and intra-route ETA information is provided to the traffic management center 211. Thus, while statistical analysis can still play a part by the center 211 in determining a traffic management plan, such analysis is rendered more accurate by knowing with a high degree of confidence where at least some vehicles will be in the future. In short, receipt of route information increases the reliability of the determined traffic management plan.

According to one embodiment, the navigation systems 201 are configured to receive information from the traffic management center 211, i.e., information regarding predicted traffic congestion to route vehicles 202 around a congested area. Thus, the method can be an iterative process, whereby traffic management center 211 receives route information from a plurality of vehicles, computes traffic congestion based on such route information, and transmits the congestion prediction back to the plurality of vehicles, which update their routes to avoid the predicted congestion. Optimal traffic management is reached by the cooperative interaction between traffic management center 211 and the navigation systems 201 installed in the commuter vehicles 202.

The effectiveness of the method described above is rendered increasingly effective when (1) a sufficient percentage of vehicles 202 on the roadways being equipped with navigation systems 201, and (2) the users of those vehicles 202 input or request route information from the navigation system 201 so that such route information is provided to the traffic management center 211. As navigation systems 201 become increasingly common, issue (1) will cease to be a concern. Issue (2), however, may remain a concern because it is recognized that considerable commuter traffic occurs along familiar routes, in which case, a user would have no reason to request the navigation system 201 to calculate a route. If the user does not request or inform the navigation system 201 of a planned route, the route information is not provided to the traffic management center 211.

In such a case, a “smart navigation system,” as described in co-owned patent application Ser. No. ______, entitled “Predictive Navigation,” (attorney docket CM08115TC), the entire contents of which are incorporated herein by reference, could provide route information to traffic management center 211 without requiring significant user interaction. A “smart navigation system” is configured to learn and remember common destinations and maintain these destinations in a database. When a user begins traveling in a vehicle 202, the smart navigation system can guess the destination from among the stored destinations, based on parameters such as the vehicle's present position, the time of day, historical travel patterns, etc. For example, if a trip begins in the early evening on a weekday and the vehicle's current position is at an address that the navigation system 201 recognizes as the user's office, the navigation system 201 might guess that the destination is the user's home. The smart navigation system can query the user and confirm the destination. If the user confirms, the navigation system 201 calculates a route from the office to home, considering current roadway conditions, of which user might be unaware. Thus, even though the user is familiar with the route home, the smart navigation system might suggest an alternate route based on information about roadway conditions. In the context of the presently disclosed method, such “smart” route information is provided to the traffic management center 211 even for familiar routes wherein a user typically would not ask the navigation system 201 to determine a route.

It should be understood that the inventive concepts disclosed herein are capable of many modifications. To the extent such modifications fall within the scope of the appended claims and their equivalents, they are intended to be covered by this patent.

What is claimed is:

1. A process for determining a traffic management plan on a roadway, comprising:
receiving information from a plurality of navigation systems located in a plurality of vehicles on the roadway, wherein, for each navigation system and each vehicle the information is indicative of a present position and a planned route of the vehicle,
predicting traffic congestion based on the received information, and
determining a traffic management plan based on the predicted traffic congestion.

2. The process of claim 1, wherein the traffic management plan comprises optimizing traffic signal light patterns on the roadway.

3. The process of claim 1, wherein the traffic management plan includes displaying a message on a roadside dynamic message sign.

4. The process of claim 1, wherein the information is received via a wireless protocol selected from dedicated short range communication (DSRC) and IEEE 802.11.

5. The process of claim 1, further comprising communicating the predicted traffic congestion to at least one of the plurality of navigation systems.

6. The process of claim 5, wherein, the at least one of the plurality of navigation systems determines a route based on the predicted traffic congestion.

7. The process of claim 1, wherein the received information from the navigation systems comprises intra-route estimated time of arrival (ETA) information.

8. The process of claim 7 wherein predicting the traffic congestion comprises aggregating the vehicle route information and intra-route ETA information from all the vehicles reporting route information.

9. A traffic control system comprising:
at least one wireless receiver configured to receive information from a plurality of navigation systems located in a plurality of vehicles on a roadway, wherein, for each navigation system and each vehicle the information is indicative of a present position and a planned route of the vehicle, and
a processor configured to predict traffic congestion based on the received information and determine a traffic management plan based on the predicted traffic congestion.

10. The system of claim 9, wherein the traffic management plan comprises optimizing traffic signal light patterns on the roadway.

11. The system of claim 9, wherein the traffic management plan includes displaying a message on a roadside dynamic message sign.

12. The system of claim 9, wherein the information is received via a wireless protocol selected from dedicated short range communication (DSRC), and IEEE 802.11.

13. The system of claim 9, further comprising:
a transmitter for communicating the predicted traffic congestion to at least one of the plurality of navigation systems.

14. The system of claim 9, wherein the processor is further configured to estimate an intra-route estimated time of arrival for each navigation system.

15. The system of claim 9, wherein the processor is configured to aggregate the data for each of the plurality of navigation systems.

16. A navigation system for use in a vehicle, comprising:
a global positioning receiver configured to determine a present position of the vehicle;
a processor configured to determine a route between the present position of the vehicle and a destination;
a wireless transmitter configured to transmit the determined route to a traffic management system; and
a wireless receiver configured to receive traffic congestion information from the traffic management system,
wherein the traffic congestion information is determined from information received from a plurality of navigation systems in each of a plurality of vehicles indicative of a present position and a planned route for each of the plurality of vehicles.

17. The system of claim 16, wherein the processor is further configured to update the determined route based on the traffic congestion information.

18. The system of claim 16, wherein the processor is further configured to determine an intra-route estimated time of arrival (ETA) for the vehicle.

19. The system of claim 18, wherein the processor is configured to initiate transmission of the determined route, present position, and/or intra-route ETA to the traffic management system.
